(19) United States
(12) Patent Application Publication
(10) Pub. No.: US 2003/0016339 A1
(43) Pub. Date: Jan. 23, 2003

(54) Exposure method and apparatus

(76) Inventor: Tetsuo Taniguchi, Ageo-shi (JP)

Correspondence Address: Oblon Spivak McClelland Maier & Neustadt, 1755 Jefferson Davis Highway, Fourth Floor, Arlington, VA, 22202, US

(21) Appl. No.: 09/571,685

(22) Filed: May 16, 2000

(30) Foreign Application Priority Data
Nov. 18, 1998 PCT/JP98/05184
Nov. 18, 1997 (JP) 9-316921

(51) Int. Cl. G03B 27/72

(52) U.S. Cl. 355/69

(57) ABSTRACT

An exposure apparatus which is capable of accurately correcting the fluctuation of image-forming characteristics that will be generated due to the absorption of irradiating light energy in an optical projecting system even in the case wherein a double exposure is performed while exchanging the pattern of reticle for every sheet of wafer. In the period TA, the exposure of the pattern of a first reticle is performed under exposure condition A, in the period TB, the process of exposing the pattern of a second reticle under exposure condition B is repeated. A coefficient representing a model of fluctuation of image-forming characteristics at the period TA as well as a coefficient representing a model of fluctuation of image-forming characteristics at the period TB are respectively determined according to the ratio of the magnitude of irradiating energy under exposure conditions A and B. Based on these coefficients, the magnitude of fluctuation ΔP of image-forming characteristics at each of the periods TA and TB is estimated, and the image-forming characteristics is corrected so as to offset this magnitude of fluctuation ΔP.

### TECHNICAL FIELD OF THE INVENTION

This invention relates to an exposure method and exposure apparatus, which are useful for transferring a mask pattern to a photosensitive substrate on the occasion of manufacturing for example a semiconductor device, a liquid crystal display device or a thin film magnetic head by making use of photolithography, and in particular, to an exposure method and exposure apparatus, which are particularly suited for use in a multiple exposure.

### BACKGROUND OF THE INVENTION

A projecting exposure apparatus or a projection aligner, such as a stepper which is designed to be employed on the occasion of manufacturing a semiconductor device, is known to exhibit fluctuations in the image-forming characteristics (e.g., distortion, best focus position, etc.) upon the absorption of exposure light in an optical projecting system. Therefore, various methods have been proposed for correcting the fluctuation up to date. According to one example of such correcting methods, an incident energy to an optical projecting system is measured at first, and then, the magnitude of fluctuation of the image-forming characteristics caused by the incident energy is estimated according to a fluctuation model of the image-forming characteristics that have been calculated in advance. On the basis of this estimated result, the optical device, which constitutes a part of the optical projecting system, is actuated through an appropriate correction mechanism.

In connection with this respect, there have been recently proposed techniques for further improving the resolution power, including a modified irradiation method wherein a reticle as a mask is irradiated with light from a secondary light source having an annular aperture or a plurality of apertures, or a method which employs a reticle provided with a phase shifter (i.e., phase shift reticle). If these methods are to be employed, the intensity distribution of irradiating light is caused to greatly fluctuate within the optical projecting system, thus causing the fluctuation in the aforementioned image-forming characteristics. In order to cope with this problem, a method has been proposed as disclosed in Japanese Patent Unexamined Publication No. 62-229838, in which a fluctuation characteristic model modified depending on the exposure conditions is employed.

In the actual exposure process however, there is a case wherein wafers of a given lot number are subjected to exposure to light under a given exposure condition, and subsequently wafers of the next lot number are subjected to exposure to light under a different set of exposure condition. In this case, the second exposure is initiated under the influence of the previous exposure condition remaining in the optical projecting system, thus causing a discontinuous change of image-forming characteristics. Therefore, it becomes difficult to perform the calculation of estimation with high precision by making use of the fluctuation model of image-forming characteristics obtained under a certain exposure condition. Further, even if this fluctuation model is produced respectively under these two different exposure conditions so as to enable the fluctuation model to be switched at the time when the exposure condition is switched to a different condition, there is still such a possibility that a correction error of the image-forming characteristics may be caused to remain as the image-forming characteristics will be discontinuously changed at the time of switching the exposure condition.

With a view to overcome this problem, Japanese Patent Unexamined Publication No. 6-45217 proposes a method wherein the exposure under a new exposure condition is suspended until the influence of the previous exposure condition is sufficiently reduced. There is also proposed, as shown in Japanese Patent Unexamined Publication No. 7-94393, a method wherein the magnitude of discontinuity (offset) in the image-forming characteristics on the occasion of switching is preliminarily measured, and this magnitude of offset is incorporated upon switching the image-forming characteristic to another one, into the image-forming characteristics to be employed after the switching.

As explained above, in the conventional method for correcting the image-forming characteristics, a fluctuation model of image-forming characteristics which has been preliminarily calculated according to the exposure condition is employed, and at the same time, the magnitude of fluctuation in the image-forming characteristics is estimated by performing a correction corresponding to the magnitude of offset at the time of exposure condition switching, the correction of image-forming characteristics being subsequently performed so as to offset this estimated magnitude of fluctuation. In the actual exposure process, however, the image-forming characteristics under these two types of exposure conditions are brought into a mixed state for a while after the exposure condition has been switched, so that even if the magnitude of offset of image-forming characteristics is taken into consideration, there is much possibility that a correction error of image-forming characteristics would be left remained if only a single fluctuation model is employed.

Further, a double exposure method has been recently noticed as the exposure method which enables to improve the imaging performance. The double exposure method is a method wherein the patterns of two or more (or two or more kinds of) different reticles are superimposed with each other on the same layer (photosensitive layer) on a wafer. For example, if the same layer is to be exposed to a mixed pattern consisting of a high density pattern and an isolated pattern, the optimum exposure conditions (e.g., the number of aperture (NA) of optical projecting system, irradiation condition, magnitude of exposure and best focus position) are caused to alter, since the state of generation of a diffracted light differs greatly depending on the pattern, i.e. a high density pattern or an isolated pattern. Therefore, the high density pattern and the isolated pattern are depicted respectively with a first reticle and a second reticle which differs from the first reticle, and then, the patterns of these two reticles are respectively exposed under an optimum exposure condition, thus performing a double exposure. As a result, these patterns can be transferred respectively at higher resolution as compared with a method wherein a mixed pattern comprising these both patterns is exposed under an intermediate exposure condition between these two optimum exposure conditions.

If, as in the case of conventional method, a photosensitive material (photoresist) whose property can be hardly changed even if a time interval between the exposure and the development thereof is relatively long is to be employed in the double exposure method, wafers of a given lot can be exposed to the pattern of a second reticle after the wafers of the same lot has been exposed to the pattern of a second reticle. However, there is a recent trend to employ a light of short wavelength as an irradiation light in view of the improvement of resolution, for instance excimer laser beam such as KrF (wavelength: 248 nm) and ArF (wavelength: 193 nm). A chemical amplification type resist which is suited for use in the application of such excimer laser beam is suitable for use in the formation of a fine pattern. However, since this chemical amplification type resist is relatively poor in chemical stability once it has been subjected to the exposure, the development thereof is required to be performed within a predetermined limited time after the exposure thereof so as to shorten the time interval between the exposure and the development. Therefore, if a double exposure is performed using this chemical amplification type resist, every wafers in one lot are required to be individually treated in such a manner that after the exposure of the pattern of a first reticle has been finished, the reticle is immediately exchanged to perform the exposure of the pattern of a second reticle, and the wafers that have been finished the exposure in this manner are then successively transferred to a development step.

If the fluctuation of image-forming characteristics of an optical projecting system caused by the absorption of thermal energy of irradiating light is to be corrected in the double exposure wherein patterns of different two reticles are irradiated to each wafer under respective different optimal exposure conditions, the image-forming characteristics tend to fluctuate in a state where the different image-forming characteristics under these two exposure conditions are mixed together. Therefore, it becomes difficult to accurately correct the fluctuation of image-forming characteristics if the factor to be taken into consideration upon exchanging the reticles is only the magnitude of offset of image-forming characteristics as in the case of the prior art. On the other hand, the aforementioned system where a second exposure of each wafer in subsequent to the exposure thereof with a pattern of a first reticle must be waited until the influence of the previous exposure condition is substantially extinguished is not practical due to its poor throughput in the exposure step, and still more, the system is hardly applicable to a photosensitive material which necessitates the shortening of resting time such as the aforementioned chemical amplification type resist.

Therefore, a first object of the present invention is to provide a method which is capable of performing an exposure under a desired imaging condition in an exposure system wherein the exposure is performed while alternately switching a plurality kinds of exposure conditions.

A second object of the present invention is to provide a method which is capable of accurately correcting the fluctuation of the image-forming characteristics resulting from the absorption of the energy of irradiating light in an optical projecting system even in a case where a multiple exposure is performed while exchanging one exposure pattern for another for every sheet of wafer.

A further object of the present invention is to provide an exposure apparatus which can be employed in the execution of the aforementioned exposure method.

### DISCLOSURE OF THE INVENTION

Namely, the present invention provides an exposure method for transferring an image of a mask pattern onto a substrate through an optical projecting system by making use of a predetermined exposure energy beam wherein the exposure of the substrate is performed by successively switching a plurality kinds of different exposure conditions, the exposure method being featured in that an image-forming characteristics of the optical projecting system is corrected for every switching operation of the exposure conditions.

In the present invention, it has been noticed that when an exposure is to be performed by alternately switching a plurality kinds of exposure conditions as in the case of a multiple exposure (e.g., a double exposure and a triple exposure), the image-forming characteristics to be obtained therefrom can be assumed to be in a state where the characteristics of each exposure condition is mixed with that of other exposure condition(s), and at the same time, the mixing ratio of the characteristics can be deemed to be constant according to the ratio of the switching operation, i.e. the ratio of irradiation energy at each exposure condition. Thus, when viewed in perspective, the image-forming characteristics can be assumed to fluctuate depending on the average fluctuation characteristics determined based on the ratio corresponding to the switching operation. Therefore, the magnitude of fluctuation of the image-forming characteristics can be predicted according to the average fluctuation characteristics, and the correction of image-forming characteristics can be performed on the basis of the predicted result. Namely, when the switching of exposure conditions is performed in a sufficiently short cycle as compared with the time constant of the fluctuation of image-forming characteristics, the correction of image-forming characteristics can be performed on the assumption that the image-forming characteristics is fluctuated according to the average fluctuation characteristics, so that the image-forming characteristics can be maintained accurately in a desired condition by merely performing a simple calculation.

In other words, in a double exposure method, for example, the image-forming characteristics can be assumed as being substantially in a mixed state of a plurality of fluctuation characteristics, thus making it possible to correct the fluctuation of the image-forming characteristics resulting from the irradiation of an exposure energy beam.

In this case, it is preferable to correct the image-forming characteristics of the optical projecting system in proportion to the ratio of each exposure time of each of plural exposure conditions. Since the mixing ratio of image-forming characteristics can be determined in proportion to the ratio of each exposure time, it becomes now possible, by making use of a small volume of calculation, to accurately estimate the magnitude of fluctuation of the average image-forming characteristics.

Further, the same photosensitive layer on a substrate may be exposed to the irradiation through a plurality of images of the mask patterns by making use of a plural number of mask patterns under different exposure conditions. This means that the exposure of predetermined patterns is performed by means of a multiple exposure wherein the exposure is effected to a single layer by switching the exposure conditions.

In this case, especially when the multiple exposure is performed while exchanging the mask pattern for every substrate, the image-forming characteristics can be assumed, according to the present invention, as fluctuating on the basis of an average fluctuation characteristics of plurality of image-forming characteristics which correspond to each mask pattern, thereby enabling to accurately maintain a desired image-forming characteristics without necessitating a complicated control.

One example of the aforementioned exposure condition is an irradiating condition of exposure energy beam, the number of apertures of the optical projecting system, or the kind of mask pattern. For example, since the permeability can be fluctuated depending on the kinds of mask pattern, the magnitude of incident energy to the optical projecting system will be caused to change.

On the occasion of performing the exposure under plural different exposure conditions, the image-forming characteristics of the optical projecting system may be corrected in proportion to the ratio of the magnitude of exposure energy beam entering into the optical projecting system at each exposure conditions. Since the mixing ratio of image-forming characteristics under plural exposure conditions can be approximately accurately estimated also by the ratio of the magnitude of incident energy, it is possible, on the basis of this ratio, to approximately accurately estimate the magnitude of fluctuation of the image-forming characteristics.

The present invention also provides an exposure apparatus for transferring an image of a mask pattern onto a substrate through an optical projecting system by making use of a given exposure energy beam, which is featured in that the apparatus comprises an exposure control component for performing an exposure to the substrate while successively switching plural different exposure conditions, and an image-forming characteristics correcting component for correcting the image-forming characteristics of the optical projecting system according to the switching operation of the exposure conditions.

According to the exposure apparatus of the present invention, it is possible to execute the exposure methods as proposed by the present invention.

It is preferable that the exposure control component is constructed such that a model of the fluctuation characteristics of the image-forming characteristics due to the absorption of exposure energy beam of the optical projecting system is preliminarily stored therein for each of the plural exposure conditions, and that when the exposure is to be performed by means of a double exposure for instance, the correction of fluctuation of the image-forming characteristics due to the absorption of exposure energy beam is performed on the basis of a model that can be obtained through the averaging of the model of the fluctuation characteristics corresponding for instance to the ratio of the magnitude of irradiation energy at each exposure condition.

### BRIEF DESCRIPTION OF THE DRAWINGS

FIG. 1 is a partially sectioned schematic view illustrating a projecting exposure apparatus to be employed in one embodiment of the present invention;

FIG. 2 is a graph explaining the feature of changes in image-forming characteristics which will be generated due to the absorption of irradiation light of the optical projecting system;

FIG. 3 shows diagrams illustrating the patterns of a couple of reticles and corresponding exposure conditions when a double exposure method is employed for the exposure;

FIG. 4 shows a graph illustrating a method of calculating a coefficient of the model of the magnitude of fluctuation of image-forming characteristics when a double exposure method is employed for the exposure in the embodiment shown in FIG. 3;

FIG. 5 shows a graph illustrating a magnitude of correction (fluctuation) of image-forming characteristics in each exposure condition when a double exposure method is employed for the exposure in the embodiment shown in FIG. 3; and

FIG. 6 shows a graph wherein a magnitude of correction (fluctuation) of image-forming characteristics at the initial portion in FIG. 5 is magnified.

### BEST MODE FOR CARRYING OUT THE INVENTION

Now, one embodiment according to the present invention will be illustrated in details with reference to the drawings.

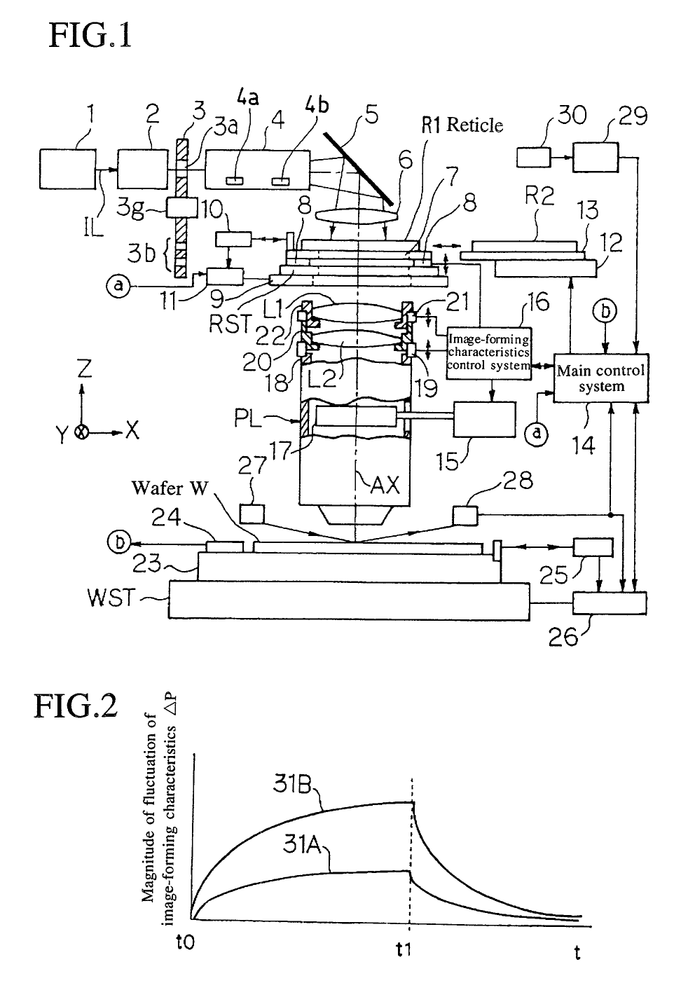

FIG. 1 shows a projecting exposure apparatus according to this embodiment. Referring to FIG. 1, the irradiation light IL employed as an exposure energy beam to be emitted from an exposure light source 1 of excimer laser such as KrF (wavelength=248 nm), ArF (wavelength=193 nm) or F₂ (wavelength=157 nm) is introduced into an illuminance-homogenizing optical system 2 comprising an shaping optical system for shaping the cross-section of irradiated light, a fly-eye lens for homogenizing illuminance distribution, etc. As for the exposure light source 1, a mercury lamp or X-rays can be also employed.

The exit surface of the irradiation-homogenizing optical system 2 corresponds to an optical Fourier transformation surface (pupil surface) against the surface of pattern of the reticle to be transferred (reticle R1 in FIG. 1), so that a turret plate 3 having various aperture stops for switching the illumination condition to the reticle is disposed in the exit surface. Namely, this turret plate 3 is provided around the rotational axis thereof with a circular aperture stop for executing an ordinary illumination, a small circular aperture stop 3a for minimizing σ value indicating coherence factor, an annular aperture stop 3b for executing an annular illumination, and a modefied aperture stop composed of four apertures arranged around the optical axis. Thus, it is designed such that a desired aperture stop can be arranged in the exit surface by rotating this turret plate 3 by way of a driving motor 3g as instructed by a main control system 14 which controls the entire operation of the apparatus. One example of the turret plate 3 is disclosed in Japanese Patent Unexamined Publication No. 9-26554 (U.S. Pat. No. 5,739,899).

The irradiation light IL that has been emitted from the irradiation-homogenizing optical system 2 and passed through a predetermined aperture stop in the turret plate 3 is then guided via an optical system 4 comprising a relay lens and a field stop, a mirror 5 for bending optical path, and a condenser lens 6 to an irradiation region of the surface of pattern (bottom surface of the reticle R1). Inside this optical system 4, there are also disposed an integrator sensor 4a for detecting the quantity of light branched from the irradiation light IL, and a reflectance monitor 4b for detecting the quantity of light reflected from the reticle R1 side. The image of pattern inside the irradiation region of the reticle R1 can be transferred via an optical projecting system PL with a projecting magnification β (β is ¼, ⅕, etc.) to an exposure region on the surface of a semiconductor wafer (hereinafter, referred to simply as “a wafer”).

As for the irradiation system comprising the irradiation-homogenizing optical system 2 and the optical system 4, it is also possible to employ an irradiation system comprising a rod type optical integrator as set forth in Japanese Patent Unexamined Publication No. 5-102003 (U.S. Pat. No. 5,179,704).

On the optical Fourier transformation surface (pupil surface) against the surface of pattern of the reticle R1 inside the optical projecting system PL, there is disposed a variable aperture stop (not shown). This optical Fourier transformation surface is also constructed such that not only a so-called shield type pupil filter for shielding irradiation light at a predetermined region around the optical axis as disclosed in Japanese Patent Unexamined Publication No. 5-234847, but also a phase filter having a phase member at a predetermined region as disclosed in Japanese Patent Unexamined Publication No. 6-124870 can be mounted thereon as demanded.

The exit surface of the illuminance-homogenizing optical system 2 is optically conjugate with the pupil surface of optical projecting system PL, so that when the light intensity distribution (a secondary light source) in the plane optically conjugate with the pupil surface of optical projecting system PL is altered by the rotation of the turret plate 3, the light intensity distribution at the pupil surface of optical projecting system PL is also caused to change. According to this embodiment, a chemical amplification type resist is coated on the surface of the wafer W, and the wafer W is held to enable the surface of the resist to agree with the image surface of the optical projecting system PL at the time of exposure.

The present invention will be further explained with reference to coordinates, wherein the Z-axis is a line parallel to the optical axis AX of the optical projecting system PL, the X-axis is a line perpendicular to the Z-axis and parallel to the surface of FIG. 1, and the Y-axis is a line perpendicular to the surface of FIG. 1.

First of all, the reticle RI is adsorptively held on a reticle holder 7 which is mounted on a reticle stage RST via three driving elements 8 each consisting of a piezo-element which is elastic in the Z-direction (only two driving elements 8 are shown in FIG. 1, the same hereinafter). This reticle stage RST is mounted on a reticle base 9 in such a manner that it is movable in the directions of X and Y, and in the rotational direction by way of a linear motor. The magnitude of expansion of the driving elements 8 can be suitably set by means of an image-forming characteristic controlling system 16 under the control of the main control system 14. The X-coordinate, Y-coordinate and angle of rotation of the reticle stage RST are measured by means of a mirror on the reticle holder 7 and an external laser interferometer 10, the measured results being fed to a reticle stage-driving system 11 as well as to the main control system 14, thereby enabling the reticle stage-driving system 11 to control the operation of the reticle stage RST on the basis of the measured values and a control command from the main control system 14.

A reticle exchange device 12 is disposed close to the reticle base 9, and a second reticle R2 is mounted on a first slider 13 of the reticle exchange device 12. The reticle exchange device 12 functions to perform the exchange the reticle R1 on the reticle holder 7 for the second reticle R2 by a second slider (not shown) and the first slider 13 in response to the control command from the main control system 14. Thereafter, the reticle R1 and the second reticle R2 are alternately mounted on the reticle holder 7 by means of the reticle exchange device 12. According to this embodiment, these reticles R1 and R2 are respectively provided with a pattern for a double exposure (as discussed hereinafter).

On the other hand, the wafer W is adsorptively held via a wafer holder (not shown) on a table 23 which is fixed to the surface of a wafer stage WST for positioning the wafer in the directions of X and Y by way of a linear motor for instance. On this table 23 are also provided a Z leveling driving mechanism for controlling, within a predetermined range, the position (focus position) in the Z-direction and inclination angle of the wafer W. The X-coordinate, the Y-coordinate and the angle of rotation of the table 23 (wafer) are measured by means of a mirror on the table 23 and an external laser interferometer 25, the measured results being fed to a wafer stage-driving system 26 as well as to the main control system 14, thereby enabling the wafer stage-driving system 26 to control the operation of the wafer stage WST on the basis of the measured values and a control command from the main control system 14.

Upon the exposure, the reticle R1 (or reticle R2) and one shot region on the surface of the wafer W are kept in a static state with a predetermined positional relationship. Then, under this condition, the image of pattern of the reticle R1 is projected to the shot region by the optical projecting system PL, after which the wafer stage WST is moved stepwise, thereby moving the next shot region of the wafer W to the exposure region to expose with the image of pattern of the reticle R1. This exposure operation is repeated by way of step-and-repeat system, thereby performing the exposure of every shot regions of the wafer W. Although the projecting exposure device of this embodiment is a stepper type as explained above, it is also possible to employ a projecting exposure device of scanning exposure type such as a step-and-scan system exposure device as set forth in Japanese Patent Unexamined Publication No. 6-291016 (U.S. Pat. No. 5,721,608). When a scanning exposure type device is employed, the reticle stage RST is also provided with a function to move in the Y-direction continuously, so that on the occasion of scanning exposure, the reticle R1 and wafer W can be synchronously scanned, by way of the reticle stage RST and the wafer stage WST, in the direction of Y at a speed ratio corresponding to a projecting magnification β.

For the purpose of keeping the surface of the wafer W coincide with the surface of image surface of the optical projecting system PL by way of auto-focus system on the occasion of the aforementioned exposure, a focus-detecting system is disposed beside the optical projecting system PL. The focus-detecting system (hereinafter, referred to as “AF sensors 27 and 28”) is composed of an optical projecting system 27 for obliquely projecting a slit image to the measuring points arranged close to the exposure region on the surface of the wafer W, and an optical receiver 28 for receiving a light reflected from the surface of the wafer W so as to re-image the slit image and outputting a focus signal corresponding to the quantity of de-focus of the surface of the wafer W from the image surface at the measuring point. The focus signal from the AF sensors 27 and 28 is then fed to the main control system 14 and the wafer stage-driving system 26, thus enabling the wafer stage-driving system 26 to control the Z-leveling driving mechanism of the table 23 so as to cause the focus signal to become a target value (the initial value: 0) that has been set by the main control system 14.

These irradiating system and optical projecting system both comprising a plurality of optical parts are incorporated into the main body of the exposure apparatus, and then the optical adjustment of these systems is performed. At the same time, the reticle stage and wafer stage, etc. are attached to and electromechanically connected with the main body of the exposure apparatus, thereby accomplishing the manufacture of the projecting exposure apparatus of this embodiment.

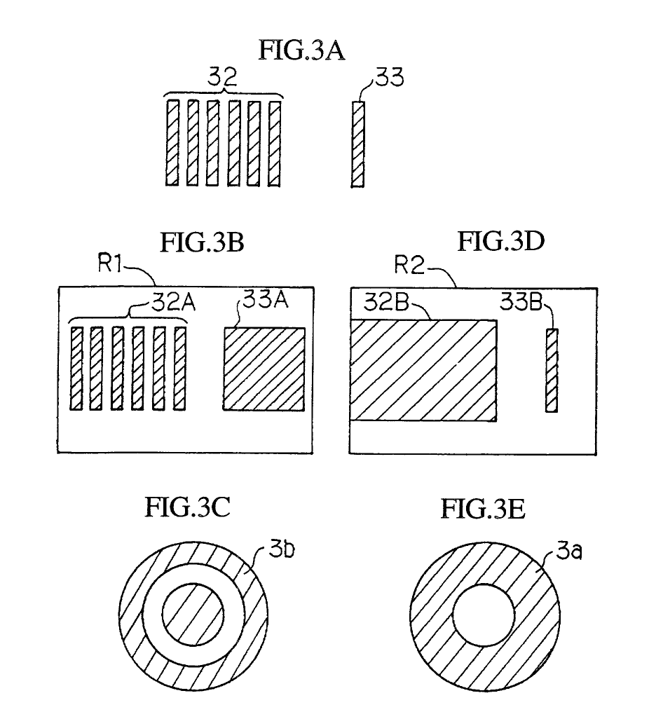

The projecting exposure apparatus of this embodiment can be employed for forming a predetermined image of circuit pattern to a layer on the wafer by means of a double exposure method. As shown in FIG. 3A, one example of the image of circuit pattern is a pattern image comprising a mixture of a high-density pattern image 32 and an isolated pattern image 33, each pattern image being corresponded to a light-shielding pattern. In this case, since an optimum exposure condition (e.g., the aperture stop of irradiation system, the numerical aperture of the optical projecting system PL, the quantity of exposure, etc.) of the high-density pattern differs from that of the isolated pattern, the reticle pattern corresponding to FIG. 3A is devided into a pattern of first reticle R1 shown in FIG. 3B and a pattern of second reticle R2 shown in FIG. 3D. In this case, the pattern of first reticle R1 is constituted by a high-density pattern 32A and a shield pattern 33A for covering the isolated pattern, while the pattern of second reticle R2 is constituted by a shield pattern covering the high-density pattern 32A and an isolated pattern 33B. The high-density pattern 32A for example may be provided with a phase shifter, thereby making the reticle R1 into a phase shift reticle.

On the occasion of projecting the pattern image of the first reticle R1 onto the surface of the wafer W, an annular aperture stop 3b as shown in FIG. 3C is employed as an aperture stop of the irradiating system. On the other hand, on the occasion of projecting the pattern image of the second reticle R2 onto the surface of the wafer W, an aperture stop 3a for a small σ value as shown in FIG. 3E is employed as an aperture stop of the irradiating system. Further, since the first reticle R1 differs from the second reticle R2 in terms of pattern existence ratio and hence the transmittance to the irradiating light IL, the energy entered in the optical projecting system PL is caused to change, depending on which reticle is to be employed.

In the case of this double exposure method as set forth in this embodiment, the image-forming characteristics of the optical projecting system PL is caused to gradually fluctuate, depending on the conditions of environment such as ambient temperature around the optical projecting system PL as well as on the quantity of incidence energy to the optical projecting system PL. For this reason, the projecting exposure apparatus of this embodiment is provided with a sensor for measuring the environment condition and a mechanism for measuring the quantity of incidence energy to the optical projecting system PL.

Namely, a detected signal from an environment sensor 30 comprising an atmospheric pressure sensor, a temperature sensor and a humidity sensor is fed through a signal processing device 29 to the main control system 14, thus enabling the main control system 14 to recognize, on the basis of this detected signal, the ambient conditions such as atmospheric pressure, temperature and humidity around the optical projecting system PL.

An irradiation quantity monitor 24 comprising a photoelectric detector is disposed close to the wafer W (wafer holder) on the table 23, and a detected signal from this irradiation quantity monitor 24 is fed to the main control system 14. By moving the light-receiving face of the irradiation quantity monitor 24 to the exposure region of the optical projecting system PL so as to detect the quantity of received light, the actual quantity of incidence energy to the optical projecting system PL as well as the transmittance (pattern existing ratio) of the reticle R1 (or R2) can be measured.

This projection exposure apparatus of the embodiment is designed such that even during the exposure, the quantity of exposure to the wafer W (an incidence energy to the optical projecting system PL) can be always monitored indirectly by an integrator sensor inside the optical system 4, and at the same time, the reflectance of the wafer W and hence the quantity of irradiation light that has been reflected by the wafer W and returned to the optical projecting system PL are also enabled to be determined by a reflectance monitor inside the optical system 4.

Next, the correcting mechanism of the image-forming characteristics of the optical projecting apparatus according to this embodiment will be explained. First of all, the driving element 8 for moving the reticle R in the direction of optical axis AX is employed for the correction of the symmetric distortion component if the optical projecting system PL is telecentric on the side of reticle. Meanwhile, if the optical projecting system PL is non-telecentric on the side of reticle, the driving element 8 is employed for the correction of projecting magnification.

As shown in FIG. 1, a lens element L2 is held in a lens frame 20 on the lens barrel 18 of the optical projecting system PL with three pieces of driving elements 19 such as piezo-element which are made in the direction of Z, while a lens element L1 is sustained in a lens frame 22 through three pieces of driving elements 21 which are mounted on the lens frame 20 and are made elastic in the direction of Z. The magnitude of expandability of these driving elements 19 and 21 is controlled by the image-forming characteristics-controlling system. Thus, the projecting magnification, the curvature of image field, symmetrical distortion component, etc. can be corrected by respectively moving the lens elements L2 and L1 which are disposed close to the reticle R1 among the lens elements constituting the optical projecting system PL in the direction of optical axis AX and by respectively inclining the lens elements L2 and L1 within a predetermined range.

Additionally, a variable pressure member 15 such as a bellows pump for controlling the internal pressure of the closed space 17 between predetermined lens elements in the optical projecting system PL is provided, so that image-forming characteristics-controlling system 16 is enabled to correct the magnification, coma-aberration, the curvature of image field, etc. by controlling the pressure inside the closed space 17 with this variable pressure member 15. When the amount of fluctuation of the image surface (best focus position) of the optical projecting system PL has been estimated, an instruction is emitted from the main control system 14 to the wafer stage-driving system 26, instructing that the offset of this fluctuation should be added to the target value of the focus signal that has been detected by the AF sensors 27 and 28. As a result, it becomes possible to allow the surface of the wafer W to follow the fluctuation of the image surface. These correcting mechanisms are required to be provided in a sufficient number corresponding to the items (the degree of freedom) which are required to be corrected. If it is impossible to completely and independently to correct the aforementioned aberration, a combination of the magnitude of driving each correcting mechanism and the magnitude of aberration should be represented by simultaneous equations so as to calculate the magnitude of each correcting mechanism for obtaining a desired magnitude of fluctuation (magnitude of correction) of the aberration. As the magnitude of correction of each aberration (image-forming characteristics) is determined by the main control system 14, the magnitude of driving the correcting mechanism (corresponding to the image-forming characteristics control system 16) is calculated for driving each correcting mechanism.

Next, a method of calculation for estimating the magnitude of fluctuation of image-forming characteristics of the optical projecting system PL due to the absorption of the irradiating light IL will be explained. As instructed by the main control system 14, the magnitude of energy of the irradiating light IL to be entered into the optical projecting system PL and the transmittance of the reticle R are measured by the irradiation quantity monitor 24. If the magnitude of energy of the luminous flux that has passed through the optical projecting system PL is to be monitored in high precision, the main control system 14 calculates the magnitude of energy of the luminous flux that has been reflected by the wafer W and returned to the optical projecting system PL by making use of the detected signal from the reflectance monitor 4b which is disposed in the optical system 4. The main control system 14 is enabled to recognize, through the detected signal from the integrator sensor 4a disposed in the optical system 4, not only the timing with which the irradiation light IL has entered into the optical projecting system PL but also the irradiation period of the irradiation light IL to the optical projecting system PL. Due to the change of internal temperature of the optical projecting system PL which will be caused in accordance with a balance between the absorption of the irradiation light IL and the heat radiation of the irradiation light IL, the image-forming characteristics thereof is caused to fluctuate correspondingly.

FIG. 2 illustrates the manner in which the image-forming characteristics of the optical projecting system PL is caused to change. In FIG. 2, the abscissa denotes the time “t” elapsed and the ordinate denotes the magnitude of fluctuation ΔP of the image-forming characteristics. The solid curves 31A and 31B represent the fluctuations of image-forming characteristics when for example the reticles R1 and R2 are employed, respectively. In the following explanation, the exposure conditions (i.e., irradiation condition, the kind of pattern of the reticle, the numerical aperture of the optical projecting system PL, the kind and existence or non-existence of the filter in the optical projecting system PL, the quantity of exposure, etc.) employed for exposure with the patterns of the first reticle R1 and the second reticle R2 are referred to as “the exposure condition A” and “the exposure condition B”, respectively.

As indicated by the curves 31A and 31B in FIG. 2, after the initiation of the irradiation of irradiation light IL to the optical projecting system PL at the time t0, the image-forming characteristics is gradually caused to fluctuate. However, when the irradiation is further continued, the absorption and radiation of heat is gradually balanced, thus causing the image-forming characteristics to saturate at a constant value. Further, when the irradiation is stopped at the time t1, the image-forming characteristics is allowed to gradually return to the original state. In this case, since the exposure condition A differs from the exposure condition B with respect to the irradiation conditions, even if the amount of incidence energy in these exposure conditions may be the same with each other as a whole, the intensity distribution of irradiation light in the optical projecting system PL differs from each other, thus causing the fluctuation characteristics to differ from each other as shown by the curves 31A and 31B. This fluctuation characteristics is determined in advance through experiments and stored as a model of fluctuation characteristics of image-forming characteristics in a memory in the main control system 14.

Specific examples of the magnitude of fluctuation ΔP of the image-forming characteristics are, for example, the magnitude of fluctuation of best focus position (the magnitude of defocus), an error of projecting magnification β and the quantity of distortion. The magnitude of fluctuation ΔP of the exposure conditions A and B is defined as ΔPA and ΔPB, respectively. If the time constants of the exposure conditions A and B are defined as τA and τB, respectively, and if the saturated values of the magnitude of fluctuation ΔP in the exposure conditions A and B are defined as PA and PB, respectively, the magnitude of fluctuations ΔPA and ΔPB as one example of the model of the fluctuation characteristics can be expressed in terms of the time “t” in the following functions. In the following model, the fluctuation in the period of: t0≦t≦t1 is represented with the irradiation-initiating time t0 in FIG. 2 being defined as 0;

ΔPA=PA{1−exp(−t/τA)} (1A)

ΔPB=PB{1−exp(−t/τB)} (1B)

If the magnitude of fluctuations ΔPA and ΔPB at time t=t1 are defined as PA1 and PB1, respectively, the model of fluctuation characteristics in the period of t1<t in FIG. 2 can be expressed in the following functions as an example. By the way, as for the model of fluctuation characteristics, a table represented in relationship with the elapsed time “t” may be employed.

ΔPA=PA1·exp{t−t1/τA)} (2A)

ΔPB=PB1·exp{t−t1/τB)} (2B)

By introducing one after another the elapsed time “t” beginning from the irradiation initiating time in these models, the magnitude of fluctuations ΔPA and ΔPB at an elapsed time “t” can be determined by the main control system 14. Since the total amount of incidence energy in period of: t0≦t≦t1 is proportional to the elapsed time “t”, this elapsed time “t” can be correlated to the total amount of incidence energy.

As explained above, the model of the fluctuation characteristics is specifically assigned to a single exposure condition, so that if the exposure condition is given, the model of the fluctuation characteristics is also changed to conform with that exposure condition. In this case, the saturation values PA and PB are coefficients each representing in what degree the magnitude of fluctuation (at the saturation level) will be generated (generally, the quantity of energy is proportional to the magnitude of fluctuation). Whereas, the time constants τA and τB are coefficients each representing at what speed the fluctuation will proceed (how much time it is required for reaching the saturation). Since the saturation values PA and PB and the values of time constants τA and τB fluctuate depending on the quantity of incidence energy (illuminance) per unit time, the saturation values PA and PB and the values of time constants τA and τB can be stored as functions in terms of the illuminance of the irradiation light.

Since the image-forming characteristics of the optical projecting system PL is also fluctuated by the atmospheric pressure, temperature and humidity which are to be detected by means of the environment sensor 30, the models of the fluctuation characteristics for determining the magnitude of fluctuation of the image-forming characteristics in relative to the change of these environmental conditions are also stored in the memory of the main control system 14. The main control system 14 can also feed a sum of the magnitude of fluctuation of the image-forming characteristics corresponding to the change of environmental conditions and the magnitude of the fluctuation of the image-forming characteristics corresponding to the quantity of incidence energy to the image-forming characteristics control system 16. This image-forming characteristics control system 16 then actuates at least one of the driving elements 8, 15, 19 and 21 to correct the image-forming characteristics so as to offset the aforementioned sum of fluctuation of the image-forming characteristics that has been fed thereto. With respect to the correction of defocus, the main control system 14 instructs the wafer stage driving system 26 to change the offset with respect to the target value of the focus signal of the AF sensors 27 and 28.

Next, one example of the operation of correcting the image-forming characteristics when the exposure is to be performed by means of double exposure method by making use of the optical projecting apparatus according to this embodiment will be explained. In this case, in order to shorten the resting time of a chemical amplification type resist coated on a wafer, an operation for exposing each wafer of one lot to the pattern image of the first reticle R1 under the exposure condition A, and an operation for exposing each wafer of one lot to the pattern image of the second reticle R2 under the exposure condition B are alternately repeated. It is preferable for the purpose of minimizing the frequency of exchanging the reticles and of enhancing the throughput of the exposure process to perform the exposure in such a manner that without performing the exchange of reticles after finishing the exposure of the first wafer, the next wafer is exposed at first to the pattern image of the second reticle R2, after which the reticles are exchanged to expose the next wafer to the pattern image of the first reticle R1. In the same manner, the exchange of reticles should preferably be performed at the middle point of the exposure process of each wafer.

When each wafer is successively exposed under the exposure conditions A and B, the image-forming characteristics can be assumed to change in a mixed state in which the fluctuation characteristics of image-forming characteristics under two exposure conditions A and B are mixed with each other at a constant ratio. However, even if the optical projecting system PL is to be irradiated in a state where the image-forming characteristics of exposure conditions A and B are mixed with each other, the passing location of irradiation light IL under the exposure condition A differs from that under the exposure condition B, and still more, the fluctuation characteristics for the exposure condition A differs from the fluctuation characteristics for the exposure condition B, so that the magnitude of fluctuation of image-forming characteristics of the exposure conditions A and B is required to be respectively calculated using separate coefficient (saturation value and time constant).

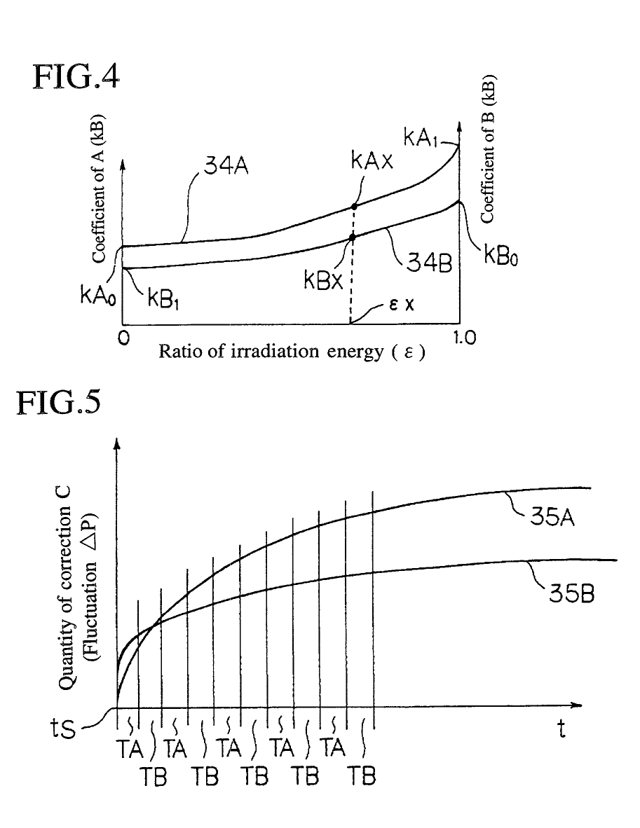

FIG. 4 shows a graph illustrating a method of determining a coefficient of the model exhibiting the magnitude of fluctuation of image-forming characteristics under the exposure conditions A and B wherein the image-forming characteristics of exposure conditions A and B are assumed as being mixed with each other. In FIG. 4, the abscissa represents the ratio ε of the quantity of irradiated energy under the exposure condition B to the total quantity of irradiated energy under two exposure conditions A and B. The quantity of irradiated energy is a product of the transmittance of the reticle, an illuminance to the reticle that can be determined by the exposure condition of resist (an incidence energy per unit time to the optical projecting system PL that can be monitored by the integrator sensor 4a within the optical system 4), and the irradiation time. Therefore, if the quantities of irradiated energy under the exposure conditions A and B are denoted by ΣEA and ΣEB, the ratio ε can be expressed as follows.

ε=ΣEB/(ΣEA+ΣEB) (3)

This ratio ε can be calculated from the output of the irradiation quantity monitor 24 shown in FIG. 1 and the parameters which determines the exposure sequence (for example, the quantity of exposure, the number of shot, etc.). Alternatively, it is also possible to determine this ratio ε by a process wherein instead of employing the wafer W, the irradiation quantity monitor 24 is set in an exposure region, and the aforementioned double exposure is actually performed, i.e. a dummy exposure sequence is actually executed so as to obtain an actual value of the integrated value of output of the irradiation quantity monitor 24, the ratio ε being determined from this actual value.

In FIG. 4, the left side ordinate denotes a coefficient kA under the exposure condition A, the right side ordinate denotes a coefficient kB under the exposure condition B, and the solid curves 34A and 34B represent the coefficients kA and kB, respectively. These coefficients kA and kB are respectively a proportional coefficient for determining, from the illuminance of irradiation light, the saturation values PA and PB (see equations (1A) and (1B)) explained with reference to FIG. 2. In this case, the value kA₀ of coefficient kA under the exposure condition A when the ratio ε is 0 is a coefficient representing a fluctuation characteristics of the image-forming characteristics when the exposure of wafers of one lot is to be continuously performed under only the exposure condition A, whereas the value kB₀ of coefficient kB under the exposure condition B when the ratio ε is 1 is a coefficient representing a fluctuation characteristics of the image-forming characteristics when the exposure of wafers of one lot is to be continuously performed under only the exposure condition B.

When the ratio ε is in the range of 0<ε<1 wherein a double exposure is to be performed against every wafer, the exposure conditions A and B are mixed with each other, and at the same time, since the rate of change in the exposure condition B is larger than that in the exposure condition A in this embodiment even if the irradiation energy is the same, the coefficient kA under the exposure condition A becomes gradually larger as the ratio ε increases from 0 as shown by the curve 34A. Contrary, the coefficient kB under the exposure condition B becomes gradually smaller as the ratio ε decreases from 1 as shown by the curve 34B. In this case, the value kA₁ of coefficient kA where the ratio ε is close to 1 as well as the value kB₁ of coefficient kB where the ratio ε is close to 0 may be determined in advance by means of simulation for instance. For example, the value kA₁ is a coefficient indicating the magnitude of fluctuation under the exposure condition A which is greatly influenced by the exposure condition B, and the coefficients kA and kB within the range of 0<ε<1 can be regarded as being an average coefficient where the influences of the exposure conditions A and B are mixed with each other.

The curve 34A can be determined in such a manner that under the condition where the ε is approximately 1, the value of the coefficient kA becomes larger than that of the coefficient kB by the value (kA₁−kB₀), i.e. the (kA₁−kA₀)·ε is added to kA₀ for each ratio ε. Likewise, the curve 34B can be determined in a manner that under the condition where the e is approximately 0, the value of the coefficient kB becomes smaller than that of the coefficient kA by the value (kA₀−kB₁), i.e. the (kB₀−kB₁)·(1) −ε) is subtracted from kB₀ for each ratio ε. This manner of calculating the values of coefficients kA and kB is regarded herein as determining an average coefficient.

Alternatively, for the purpose of more accurately determining the characteristics of the curves 34A and 34B, the values of coefficients kA and kB may be confirmed in advance through exposure experiments while changing the ratio ε from 0 to 1 in stepwise, the resultant values being utilized for expressing the characteristics of the curves 34A and 34B in terms of the ratio ε (such as a secondary function) or in a table where the characteristics of the curves 34A and 34B are indicated at every predetermined step of the ratio ε. In this case, the function or the table may be stored in the memory in the main control system 14, thus enabling to determine the values of coefficients kA and kB from the ratio ε on the occasion of exposure. Although the coefficients kA and kB shown in FIG. 4 are coefficients for determining the saturation values PA and PB, the characteristics of time constants τA and τB can be also determined in the same manner as those of the curves 34A and 34B shown in FIG. 4.

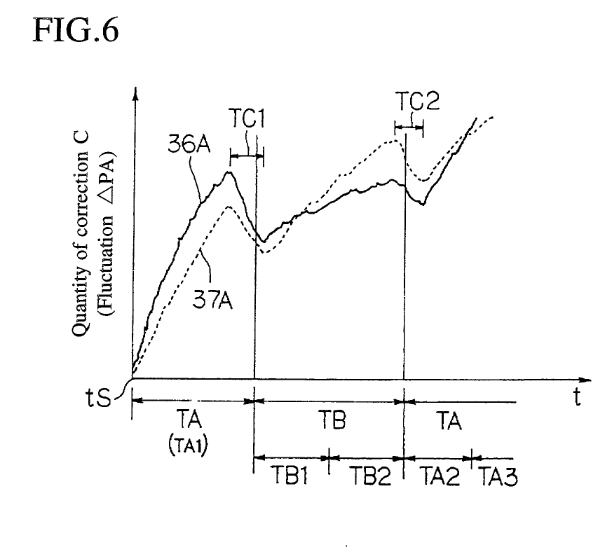

Next, the correcting operation of image-forming characteristics on the occasion of double exposure will be explained with reference to FIGS. 5 and 6. FIG. 5 shows a case wherein the double exposure is performed while alternately repeating the exposure conditions A and B starting from the time tS when the optical projecting system PL shown in FIG. 1 is in a sufficiently cooled state. In FIG. 5, the abscissa denotes the elapsed time “t”, and the ordinate denotes absolute values of the quantity of correction C of the image-forming characteristics. In this case, the quantity of correction C is a value whose absolute value in relative to the magnitude of fluctuation ΔP of the image-forming characteristics is the same but differs in sign. Since this double exposure is performed by exchanging the reticles once for each wafer, the period TA in which the exposure is performed under the exposure condition A and the period TB in which the exposure is performed under the exposure condition B are alternately repeated in an approximately predetermined cycle. The ratio ε in the quantity of irradiated energy between the exposure condition A and the exposure condition B is defined herein as “ex”. In this case, the main control system 14 functions to determine, on the basis of the characteristics of the curves 34A and 34B of FIG. 4 which have been stored in advance, the values kAx and kBx of the coefficients kA and kB under the exposure conditions of A and B at the ratio εx. Likewise, the coefficients of time constant can be determined from this ratio εx.

On the basis of these coefficients, the main control system 14 is enabled, through the models of fluctuation characteristics shown in the aforementioned equations (1A) to (2B) for instance, to sequentially calculate the magnitude of fluctuations ΔPA of the image-forming characteristics under the exposure condition A in the period TA as well as the magnitude of fluctuations ΔPB of the image-forming characteristics under the exposure condition B in the period TB. In FIG. 5, the magnitude of fluctuations ΔPA and ΔPB of the image-forming characteristics under the exposure conditions A and B are respectively represented by the solid curves 35A and 35B. Even if the optical projecting system PL is in a sufficiently cooled state (t=tS), the values of magnitude of fluctuations ΔP (ΔPA and ΔPB) of the image-forming characteristics differ slightly from each other due to fact that the optical path in the optical projecting system PL differs depending on the exposure conditions A and B, resulting in a slight difference in the quantity of correction C.

Then, by means of the main control system 14, the value of quantity of correction C for the period TA is set so as to offset the magnitude of fluctuations ΔPA that has been calculated under the exposure condition A, and the value of quantity of correction C for the period TB is set so as to offset the magnitude of fluctuations ΔPB that has been calculated under the exposure condition B. By doing so, the magnitude of fluctuation of the image-forming characteristics can be properly corrected all the time even if the magnitude of fluctuation of the image-forming characteristics differs depending on each exposure condition.

Next, how the correction can be dealt with under each exposure condition by the calculation to determine one group of the coefficients kAx and kBx which are defined in FIG. 4 in spite of the alternate switching between the exposure conditions A and B will be explained with reference to FIG. 6. FIG. 6 is an enlarged view of the initial portion of the curve 35A of exposure condition A shown in FIG. 5. In FIG. 6, the solid curve 36A denotes an actual magnitude of fluctuations ΔPA of the image-forming characteristics that has been obtained under the exposure condition A. This magnitude of fluctuations ΔPA changes remarkably in the period TA where the exposure is performed under the exposure condition A, but changed moderately in the period TB where the exposure is performed under the exposure condition B. The falling of the curve 36A in both periods TC1 and TC2 at the boundary portion between the period TA and the period TB coincides with the exchange time of reticles or the exchange time of wafers, indicating a state wherein no irradiation light is irradiated. In FIG. 5, this falling portion of the magnitude of fluctuations ΔP is omitted. Ideally speaking, a correction should be made in conformity with this change in the solid curve 36A. However, as a matter of fact, it is very difficult to strictly calculate the mixed state of the exposure conditions A and B.

The dotted curve 37A shown in FIG. 6 indicates the magnitude of fluctuations ΔPA (when the sign of this value is reversed, it becomes the quantity of correction C for the image-forming characteristics) of the image-forming characteristics that has been calculated according to the average coefficients of the exposure conditions A and B as indicated in FIG. 4. With regard to the period TB, the quantity of correction C for the image-forming characteristics is determined on the basis of the curve 35A of FIG. 5. Since the exposure conditions A and B are switched to each other at a sufficiently short intervals as compared with the time constant of the fluctuation of image-forming characteristics in this example, the error of correction (a difference between the curve 36A and the curve 37A) would be sufficiently minimal and hence negligible. As explained above, it is possible, according to this example, to very precisely correct the magnitude of fluctuation of image-forming characteristics resulting from the changes of incidence energy to the optical projecting system PL or of environmental conditions even in the case where the exposure is performed by means of double exposure method involving the exchange of reticles for every wafer.

Referring to FIG. 6, during the period TA starting form the time tS (TA1), the pattern image of the first reticle R1 is irradiated to the first wafer, and during the first half period TB1 of the next period TB, the pattern image of the second reticle R2 is irradiated to the first wafer. Further, during the latter half period TB2 of the period TB, the pattern image of the second reticle R2 is irradiated to the second wafer, and during the first half period TA2 of the next period TA, the pattern image of the first reticle R1 is irradiated to the second wafer. Further, during the latter half period TA3, the pattern image of the first reticle R1 is irradiated to the third wafer, and thereafter, the exchange of reticles is performed at the middle point of the exposure of each wafer.

The device such as a semiconductor device can be manufactured by a process comprising the step of designing the function and performance of the device, the step of manufacturing a reticle on the basis of the aforementioned design step, the step of manufacturing a wafer from a silicon material, the step of exposing the wafer to the pattern of reticle by making use of the exposure apparatus of the aforementioned embodiment, the step of assembling the device (including a dicing step, a bonding step and a packaging step), and the step of inspection.

In the aforementioned embodiments, a couple of reticles, i.e. the reticle R1 and reticle R2 are prepared for the purpose of performing a double exposure. However, it is also possible to employ a reticle wherein a right half portion thereof is depicted with a first pattern, and a left half portion thereof is depicted with a second pattern, thereby enabling these first and second patterns to be alternately exposed.

In the aforementioned embodiments, the exposure conditions to be switched are limited to two kinds, i.e. the conditions A and B. However, the present invention is also applicable in the same manner to the case where the exposure conditions are three of more. Namely, when the exposure conditions are three kinds, FIG. 4 is employed as a three-dimensional graph so as to determine the coefficients indicating the magnitude of fluctuation of image-forming characteristics from the ratio in quantity of irradiation energy among three exposure conditions.

Further, it is also possible to simplify the aforementioned embodiment in the application thereof. For example, where there is a little difference between the curve 35A of the exposure condition A and the curve 35B of the exposure condition B in FIG. 5, the magnitude of fluctuations ΔP can be calculated by making use of only one kind of coefficient which is an intermediate between the curves 35A and the curve 35B, thereby applying the same correction to both exposure conditions A and B. It is advantageous in this case in that the load of calculation in the main control system 14 can be alleviated and the administration of coefficients may also be facilitated.

Further, the correction of image-forming characteristics can be performed by approximating the curves 35A and 35B of FIG. 5 to a straight line.

As one example of other simplifications, the magnitude of fluctuation on the occasion of exposure under the exposure condition A is calculated using an equation where the exposure condition A is 100% (ε=0), and the magnitude of fluctuation on the occasion of exposure under the exposure condition B is calculated using an equation where the exposure condition B is 100% (ε=1), thus enabling the sum of these two exposure conditions to be used as a quantity of correction. In this method, the magnitude of fluctuation is simply calculated independently without paying attention to the effect of the mixing of two exposure conditions, thereby disregarding the graph of FIG. 5. This method is useful in the case where the influence of the mixing of two exposure conditions is minimal, since the load of calculation as well as the load of setting the coefficients can be minimized.

The present invention should not be construed as being limited to the aforementioned embodiments, but should be understood as capable of taking various modifications within the spirit of the present invention.

### Industrial Applicability

According to the present invention, since the image-forming characteristics of the optical projecting system is corrected according to a switching operation of the exposure conditions, it is possible, in the multiple exposure where a plurality of exposure conditions are alternately switched, to suppress the fluctuation of image-forming characteristics and to accurately maintain the imaging in a desired condition without inviting the deterioration of throughput at the step of exposure.

Further, when the image-forming characteristics of the optical projecting system is to be corrected in proportion to the ratio of each exposure time of each of plural exposure conditions, the fluctuation of image-forming characteristics can be easily suppressed by simply performing a simple calculation.

Further, when the same photosensitive layer on a substrate is exposed to the irradiation through a plurality of images of mask patterns by making use of a plural number of mask patterns under different exposure conditions, it is advantageous in that the fluctuation of image-forming characteristics due to the absorption of exposure energy beam in the optical projecting system can be accurately corrected even in the situation where a multiple exposure is performed by exchanging the pattern of mask (reticle) for every substrate (wafer).

Moreover, when the exposure condition is an irradiating condition of exposure energy beam, the number of apertures of the optical projecting system, or the kind of mask pattern, an exposure condition whose influence on the image-forming characteristics is prominent is taken into consideration, so that the fluctuation of image-forming characteristics can be accurately corrected. Further, when the image-forming characteristics of the optical projecting system is corrected in proportion to the ratio of the magnitude of exposure energy beam entering into the optical projecting system at each exposure conditions on the occasion of performing the exposure under plural different exposure conditions, the fluctuation of image-forming characteristics can be accurately corrected.

The exposure apparatus of the present invention can be advantageously employed for executing the exposure methods as proposed by the present invention.

1. An exposure method for exposing a substrate to an image of a mask pattern through a optical projecting system, comprising:
sequentially switching a plurality of different exposure conditions from one to another upon the exposure of a layer of the substrate; and
correcting image-forming characteristic of the optical projecting system in consideration of switching the exposure conditions.

2. The exposure method according to claim 1, wherein the image-forming characteristic of the optical projecting system is corrected according to a ratio of the amount of energy of an exposure beam to be entered into the optical projecting system under each exposure condition on the occasion of exposing the substrate to light under the plurality of different exposure conditions.

3. The exposure method according to claim 2, wherein the image-forming characteristic of the optical projecting system is corrected according to a ratio of each exposure time of the plurality of different exposure conditions.

4. The exposure method according to claim 2, wherein a parameter for calculating a fluctuation of the image-forming characteristic is determined according to the ratio of the amount of energy of exposure beam to be entered into the optical projecting system at each of the plurality of different exposure conditions.

5. The exposure method according to claim 2, wherein the exposure beam to be entered into the optical projecting system includes a reflection beam to be reflected from the substrate.

6. The exposure method according to claim 1, further comprising:
providing a plurality of mask patterns; and
wherein a plurality of images of the mask patterns are projected onto the layer of the substrate under the different exposure conditions, respectively.

7. The exposure method according to claim 6, wherein a plurality of regions of the substrate are respectively exposed by making use of a first mask pattern selected from said plurality of mask patterns, after which said plurality of regions of the substrate are respectively exposed by making use of a second mask pattern which is different from said first mask pattern.

8. The exposure method according to claim 1, wherein said exposure condition includes at least one of a condition related to the irradiation of exposure energy beam to the mask pattern, a condition related to the numerical aperture of the optical projecting system, a condition related to the type of the mask pattern, and a condition related to an optical filter disposed in the optical projection system.

9. The exposure method according to claim 8, wherein said condition related to the irradiation of exposure energy beam includes an energy intensity distribution in a plane approximately conjugate with a pupil surface of the optical projecting system, in an irradiating system for irradiating the exposure energy beam to the mask pattern.

10. The exposure method according to claim 8, wherein said mask pattern includes a phase shift pattern.

11. The exposure method according to claim 8, wherein said optical filter is designed to limit the exposure beam in a predetermined region in the vicinity of an optical axis of the optical projecting system.

12. The exposure method according to claim 8, wherein said optical filter comprises a phase member at a predetermined region.

13. The exposure method according to claim 1, wherein said image-forming characteristic includes at least one of the characteristics selected from the group consisting of magnification, the curvature of image field, distortion and coma-aberration.

14. The exposure method according to claim 1, wherein said correction of image-forming characteristic includes an adjustment in position of a lens element constituting part of the optical projecting system.

15. The exposure method according to claim 4, wherein said parameter includes a coefficient of a model function for calculating the fluctuation of the image-forming characteristics of the optical projecting system resulting from an irradiation of the exposure beam.

16. A device manufactured by making use of the exposure method defined in claim 1.

17. An exposure apparatus which transfers an image of a mask pattern onto a substrate through an optical projecting system, comprising:
an exposure system which performs an exposure of a layer on the substrate while sequentially switching plural different exposure conditions from one to another; and
a correcting system which corrects image-forming characteristic of the optical projecting system in consideration of the switching of the exposure condition.

18. An exposure apparatus according to claim 17, wherein said correcting system is designed to correct the image-forming characteristic of the optical projecting system according to a ratio of the amount of energy of an exposure beam to be introduced into the optical projecting system under each of the plurality of different exposure conditions.

19. The exposure apparatus according to claim 17, wherein said exposure condition includes at least one of a condition related to the irradiation of exposure energy beam to the mask pattern, a condition related to the numerical aperture of the optical projecting system, a condition related to the type of the mask pattern, and a condition related to an optical filter disposed in the optical projection system.

20. The exposure apparatus according to claim 17, which further comprises, for the purpose of changing said condition related to the irradiation of exposure energy beam, an optical member for changing an energy intensity distribution in a plane approximately conjugate with a pupil surface of the optical projecting system, within an irradiating system for irradiating the exposure beam to the mask pattern.

21. The exposure apparatus according to claim 17, wherein said correcting system comprises a driving system for actuating a lens element constituting part of the optical projecting system.

22. The exposure apparatus according to claim 17, wherein said correcting system comprises a driving system for actuating a mask having said mask pattern.

23. The exposure apparatus according to claim 17, wherein said correcting system comprises a pressure controller for adjusting a pressure of a closed space in the optical projecting system.

24. The exposure apparatus according to claim 17, which further comprises an environment sensor for checking an environment in which the exposure of substrate is to be performed, and said correcting system is designed to correct the image-forming characteristic of the optical projecting system by also taking the information obtained from the environment sensor into consideration.

25. The exposure apparatus according to claim 17, wherein the substrate is exposed in a scanning exposure manner while moving the substrate.
